(19) United States
(12) Patent Application Publication
(10) Pub. No.: US 2004/0064345 A1
(43) Pub. Date: Apr. 1, 2004

(54) Internet claims handling services

(76) Inventors: Setrak A. Ajamian, Pasadena, CA (US); Harouteoun S. Ajamian, Pasadena, CA (US)

Correspondence Address: CISLO & THOMAS, LLP, 233 WILSHIRE BLVD, SUITE 900, SANTA MONICA, CA, 90401-1211, US

(21) Appl. No.: 10/259,701

(22) Filed: Sep. 27, 2002

(51) Int. Cl. G06F 17/60

(52) U.S. Cl. 705/4

(57) ABSTRACT

A method by which insurance claims may be handled on an on-going and continuous basis 24 hours a day, 7 days a week. By providing Internet or web-based document repository and distribution services, insurance companies, approved vendors, and independent adjusters may all address the loss or claim of an insured via the maintenance of such a web-based system by a service provider. In establishing certain methodological protocols, the present invention enables claims to be addressed in a rapid fashion to the benefit of insurers due to reduced costs and insureds due to quick response and more minimal damage.

### BACKGROUND OF THE INVENTION

1. Field of the Invention

This invention relates to the handling of insurance claims and more particularly to a method involving a web- or Internet-based system that allows for the coordinated uploading, sharing, and distribution of claim-related documents and documentation.

2. Description of the Related Art

When an individual purchases an insurance contract or pays premiums thereon, the insured does so in light of certain risks that involve the loss of the insured property. When losses do occur, the insurance company is then obligated to pay for the loss or damage for which it has contracted with the insured. In order to prevent fraud and in order to properly compensate the insured, the insurance company generally investigates the loss or damage related to the claim. Under some circumstances, it is very important to immediately address the problem, as the on-going damage may further inflict injury to the property that the insurance company may be responsible for. Consequently, insurance companies and similar institutions are concerned about the expenses arising from compensating insureds, as well as minimizing such losses. While prior attempts in the art have not achieved the utility of the present invention, such approaches have attempted to address certain insurance and insurance claim related situations. These include:

The U.S. Pat. No. 6,199,115 B1 to DiRienzo, is directed to an attachment integrated claims system and operating method therefor. As shown in FIG. 3, the overall system includes computer components 200 located in the healthcare provider's office and the computer components 300 located on the premises of the insurance company. Infrastructure 400, which advantageously may be an existing on-line service company, is used to facilitate communication between the components 200 and the service provider's office and the components 300 at the insurance company. Following the method of FIGS. 2A and 2B, at step S103, a member of the service provider's office staff accesses the attachment integrated Claims (AIC) software stored in non-volatile memory on the service provider's computer system 210. Contained within the AIC software are PAC forms for insurance companies using the AIC system.

Once an insurance company has been identified, the fields needed to complete the insurance company's PAC form are displayed on screen 212 of system 210. Needed patient information is then entered into the PAC form on the computer screen 212. In step S104, the patient's X-ray is digitized. During step S105, the PAC application is formed from the electronic PAC form and the digitized patient's X-ray. The completed PAC application is then transmitted to the insurance company at step S106.

The U.S. Pat. No. 6,182,048 to Osborn et al., is directed to a system and method for automated risk-based pricing of a vehicle warranty insurance policy. As shown in FIG. 1, processor 14 receives a request for a vehicle warranty policy from a customer for a particular vehicle. The processor 14 receives the request via an electronic channel such as the telephone 20 or the internet 22. Processor 14 receives the request from the input source 26 and uses a risk-based pricing algorithm obtained from an analytical tools unit 28 to determine a price for the request, as well as suggest terms and conditions for the priced policy. Using the risk-based pricing algorithm, the processor 14 partitions the vehicle listed in the request into a plurality of components that comprised the assembly. The processor 14 determines a correlation between the failure rates of each of the plurality of components and costs to repair the failed component with vehicle warranty related information contained in the plurality of data bases 16 using various evaluation applications obtained from the analytical tools unit 28.

The U.S. Pat. No. 6,076,066 to DiRienzo et al., is directed to an attachment integrated claims system and operating method therefor. Given the combination of the customizable claim form on the service provider's computer 210 and the use of any non-restrictive communications channel, the insurance companies are able to freely modify information requirements demanded of the service providers. Placing AIC software packages in the provider's offices and in the insurance company processing centers, where the packages are coordinated with one another, allows every provider to transmit claim form updates to every payer. As shown in FIG. 6B, the interchange between the provider's office and the insurance company can be performed using an on-line service or internet service provider, providing that the service provider permits 8-bit file interchanges.

The U.S. Pat. No. 6,052,631 to Busch et al., is directed to a method and system for facilitating vehicle inspection to detect previous damage and repairs. As shown in FIG. 1, inspection facilitator 101 comprises an inspection engine 102, an inspection user interface 103, and one or more data repositories 104 and 105 for storing vehicle-related and inspection-related information. The inspection engine 102 sends inspection instructions to the inspection user interface 103, which directs the inspection of a vehicle 110 by a technician 120 or by an apparatus. FIG. 12 is an example display screen of a vehicle's certificate of title modified to show the results of an after-repair inspection performed using the inspection facilitator.

The inspection facilitator generates customized reports that contain certain information, for example, the reporting of non-conformities in certain areas and not others. For example, a report for use in litigation can be generated to report a likely site or cause of a failure in a certain vehicle part, or other factors related to liability and personal injury claims. As another example, a report can be generated for insurance adjustors, which reports the extent and adequacy of past repair on vehicles of a similar type and the extent and cost of current repair.

The U.S. Pat. No. 5,956,691 to Powers, is directed to a dynamic policy illustration system. The dynamic policy illustration system (DPIS) 20 dynamically demonstrates the interaction of the risk elements of a life insurance policy illustration. This is achieved by providing a DICS main screen display 56, as shown in FIGS. 3-15, and other displays 58, shown in FIGS. 16-19. The DICS main screen display 56 includes a current illustration screen display, shown in FIG. 3, a life insurance balance sheet display, shown in FIG. 7, a “your life in current illustration expectancy” display, shown in FIG. 11, an illustrated and premiums display, shown in FIG. 15, and an illustration X vs. benchmark values display, shown in FIG. 20. The client can enter, modify, or otherwise change the variables that effect policy performance and instantly view the effect on future policy values over his/her lifetime.

The U.S. patent application Ser. No. 2001/0027403 A1 to Peterson et al., is a pre-patent publication, which the Patent Office has now instituted with respect to certain applications filed after November of 2000, and wherein the application is directed to a method of providing targeted information to an insured patient and/or to a health care provider based on information assembled and submitted at the time of the insured patient's visit to a health care provider. The targeted information is based on claim data which is imputed into a claim adjudication program through an interchange between the health care provider and a payor.

These prior attempts in the art have not achieved a convenient or useful means by which insurance claims may be handled 24 hours a day, 7 days a week and with which documents may be uploaded to a central web site and made available for distribution to the appropriate interested parties. Consequently, the art would be advanced by such a system. Such a system is disclosed herein. It constitutes a significant portion of the present invention.

### SUMMARY OF THE INVENTION

The present inventive method and system is directed to a property insurance claims servicing network having to do with the mitigation, and restoration and adjusting of damages as may be required with respect to emergency services. A sponsoring company, offering the services, would provide a methodology by which insurance companies can subscribe to the service and have the service provider oversee appraisal orders, contractors and insurance personnel. Through the service, information via the internet can be accessed with the service providing company overseeing the work being done and by exercising some control over the emergency or non-emergency services that are normally required should any catastrophic property insurance loss occur, such as water damage, fire damage, and the like.

The present invention provides on-going and continuous insurance claim services 24 hours a day, 7 days a week. Using a web-based system, documents may be exchanged and distributed between the interested parties. Additionally, vendors can be notified of an insured's claim and if necessary, immediately proceed to remedy or repair the damage, thereby minimizing further damage. Once the claim has been initially addressed, the documentation regarding the claim may be uploaded to the web site for inspection and distribution by other interested parties such as the insurer or any independent adjuster.

If the claim is made not on an emergency basis, more time can be taken in order to address the concerns and needs of the insured, but the same process is generally implemented. The vendor, insurance adjuster, and/or the independent adjuster contacts and visits the insured and the lost site and makes what repair or documentation necessary. The documentation, estimates, or other documents are then uploaded to the web site for inspection and review by the insurer or otherwise. Approval procedures and the ability to inquire with regards to certain specific issues arising in the claim can then be addressed.

### OBJECTS OF THE INVENTION

It is an object of the present invention to provide an insurance claim system that is based upon Internet principles.

It is another object of the present invention to provide an insurance claim system that is available 24 hours a day, 7 days a week.

It is yet another object of the present invention to better address the claims of insureds.

It is yet another object of the present invention to aid insurance companies in addressing losses or claims of insureds.

It is yet another object of the present invention to minimize further loss once an insurance claim has been made by efficiently pursuing repair and remedy for the loss or damage.

These and other objects and advantages of the present invention will be apparent from a review of the following specification and accompanying drawings.

### BRIEF DESCRIPTION OF THE DRAWINGS

FIG. 1 is a flowchart generally indicating the initial submission of an emergency claim to the service provider.

FIG. 2 is a flowchart showing the course or progress of a non-emergency claim or contractor direct claim through the method of the present invention.

FIG. 3 is a flowchart showing an alternative embodiment of the present invention wherein an independent adjuster is involved handling or pursuing a non-emergency claim.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

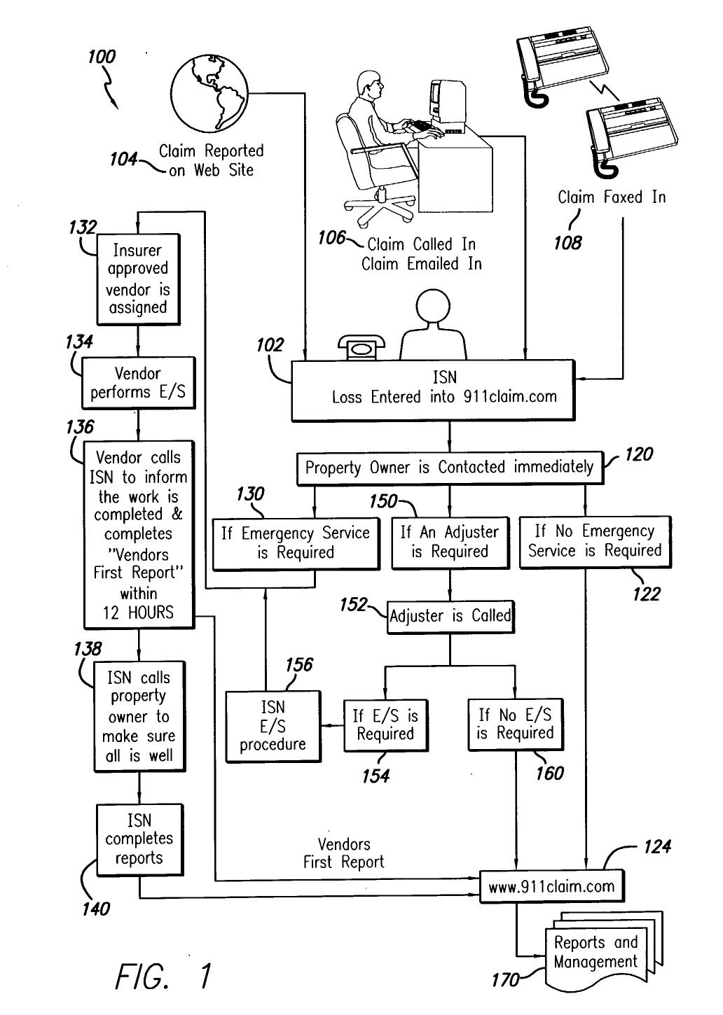

As shown in FIG. 1, the emergency claim flowchart 100 shows the steps necessary and/or sufficient to achieve the present invention. One of the important advantages of the present invention is that it allows rapid settlement of insurance claims under emergency circumstances where additional loss of property or inconvenience on the part of the insured may be experienced if delay were to occur in postponing such settlement. Central to the emergency claim processing system 100 is the claim handling service provider 102, which may receive claims from a web site 104 by voice or email correspondence 106, by fax 108, or by other known means of communication or those developed in the future.

Once a claim has been submitted to the service provider 102, the service provider immediately contacts the property owner 120. In contacting the property owner 120, inquiry and/or determination is made as to whether or not emergency service is required. If no emergency service is required 122, then the claim may be handled through a web site available over the Internet, such web site herein denominated as www.911claim.com 124. As described in more detail below, the web site claim handling service allows for the submission, review, and exchange of important claim-evaluation information that allows for the quicker evaluation and settlement of an insured's claim.

If emergency service is required 130, an insurer-approved vendor is assigned 132, who then performs the emergency services 134. Once the emergency services have been performed, the vendor communicates with the service provider 102 to inform the service provider that the work is completed. The vendor then completes a “Vendor's First Report” within an appropriate time period such as 12 hours as indicated in step 136. The service provider 102 then contacts the property owner to ensure that such work has been completed to the satisfaction of the property owner 138. The service provider then completes the pertinent reports 140 and then submits the reports to the web site 124. The Vendor's First Report as referred to in step 136 is also submitted to the web site 124 by the vendor.

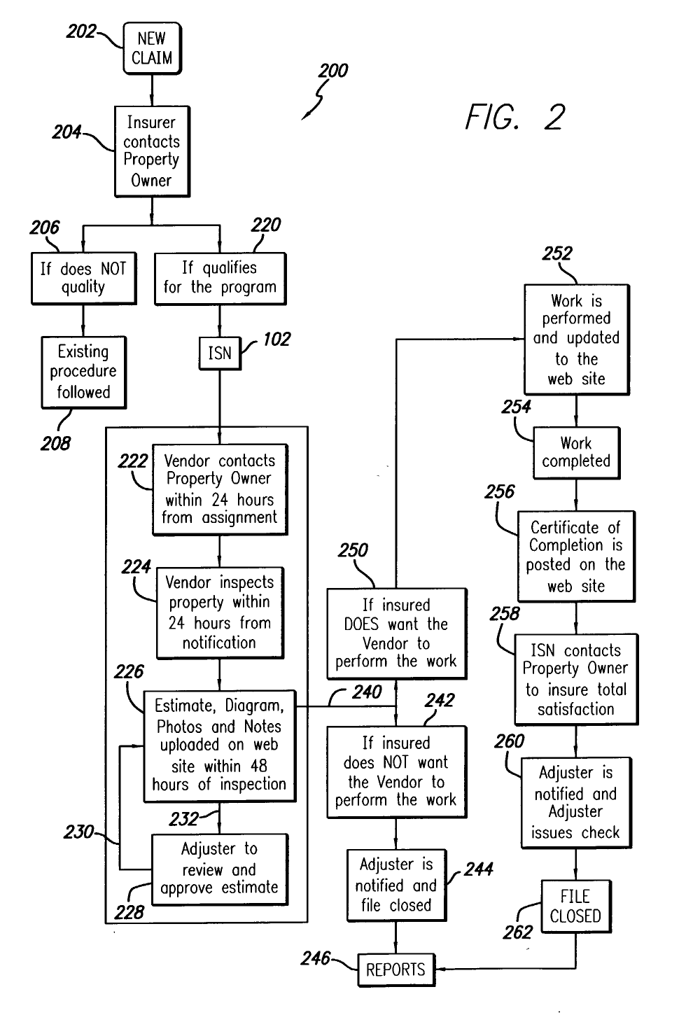

If upon contacting the property owner at step 120 it appears that an adjuster is required 150, then an adjuster is contacted 152 to evaluate whether or not emergency service is required. If emergency service is required 154, then the service provider's emergency service procedure 156 is invoked and the steps beginning at step 132 are then performed with the reports going to the web site 124. If no emergency service is required 160, then the claim is handled through the web site 124. Ultimately, all the reports, information, and documentation are then made available through reports and claims management services 170, as a result of the lodging of such information with the web site 124. As shown in FIG. 2, a method for processing claims 200 issued, where new claims can be handled by web- or Internet-assisted handling.

In FIG. 2, once a new claim arises, the insurer initially contacts the property owner 204. If the claim does not qualify for the web-assisted program 206, the existing procedure established by the insured is followed 208. If the claim does qualify for the program 220, the service provider 102 is contacted, which service provider may then enter the loss or claim into the web site or other Internet-available claim handling system of the present invention. The service provider 102 then contacts the vendor, who in turn contacts the property owner 222 regarding the claim. The vendor's contacting of the owner may take place within a certain reasonable period of time, such as 24 hours. The vendor then inspects the property 224 at some reasonable interval after contacting the owner. Such reasonable time period for inspection may also be 24 hours.

The vendor then estimates, diagrams, photographs, notes, or otherwise documents the claim. The documentation is then uploaded 226 to the web site 124 within a reasonable amount of time such as approximately 48 hours. An adjuster then accesses the web site to review and approve the estimate 228. The adjuster may be notified by email or the like that the vendor's documentation is now available on the web site 124. Alternatively, the web site itself may monitor activity of the vendor in order to notify the adjuster that such documentation may need to be reviewed. The adjuster and the vendor then engage in dialogue 230, 232 with respect to the documentation for the loss.

Once an agreement or understanding has been reached 240, the insured property owner will then decide whether or not he or she wants the vendor to perform the work. If the insured does not want the vendor to perform the work 242, then the adjuster is notified and the file is closed 244 with the associated reports 246 then generated and filed on the web site 124. Alternatively, if the insured does want the vendor to perform the work 250, then the work is performed and the information on the web site 124 is updated or supplemented in order to reflect the activity 252.

The work is then completed 254, and a certificate of completion is posted on the web site 124 at step 256. The service provider 102 then contacts the property owner to ensure that the owner is satisfied with the work performed in step 258. The adjuster is then consequently notified of the owner's feedback, and the adjuster then issues the check to the vendor for the work performed at step 260. The file is then closed at step 262, and the appropriate reports have been generated at step 246.

All the reports and documentation are made available through the web site 124, so that the interested parties can keep track of the activities without having to accommodate each individual person's schedule. The Internet allows the sharing of information in a secure manner (as by password or otherwise), such that the information is available almost instantaneously at the convenience of all parties, while any specific matters may be addressed by more instant and spontaneous means such as telephone calls or the like. In this manner, the documents are available to authorized parties without the inconvenience and delay of having to accommodate the bureaucracies of different individuals and/or individual companies.

The foregoing procedure may be especially advantageous when a vendor is needed to perform the work on an emergency or contemporaneous basis.

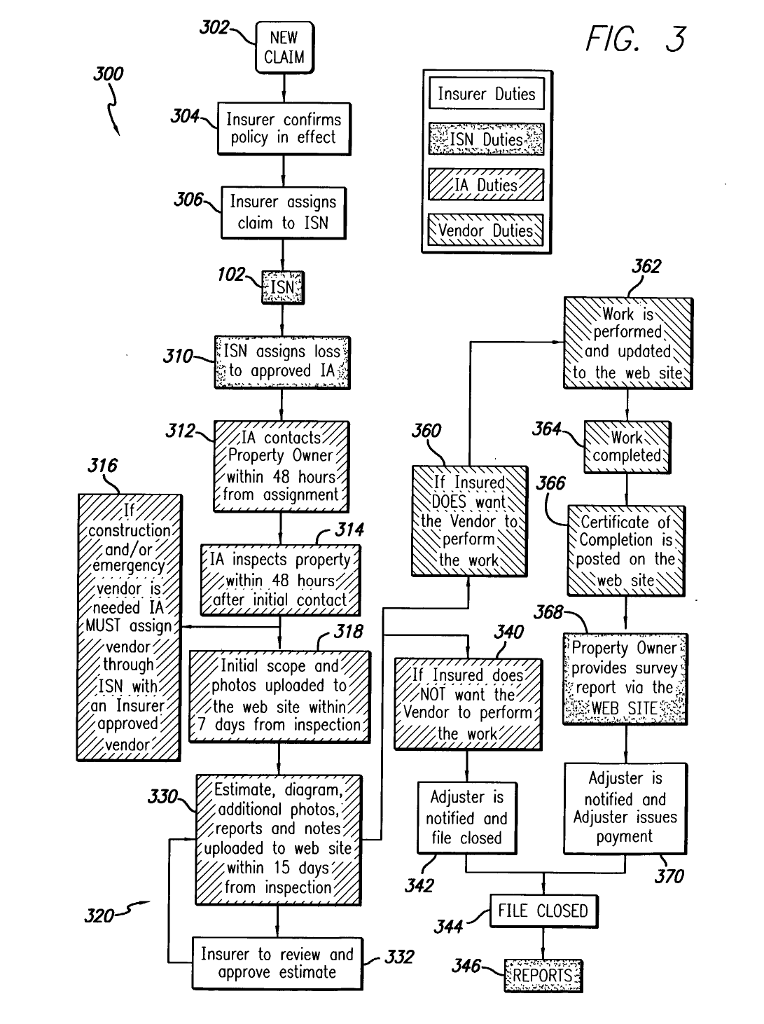

As shown in FIG. 3, an insurance adjuster may also be used to good advantage in the present method by effecting the settlement of the insured's claim.

As shown in FIG. 3, the steps taken in conjunction with the web-based claims handling service as shown in the process in FIG. 3, the insurance adjuster process 300 arises with the demand regarding a new claim 302. The insurer then confirms that a policy is in effect for the claim 304, and if the policy is in effect, the claim may be assigned to the service provider 102. The service provider assigns the loss or claim to an approved, such as an insurer-approved, adjuster 310. The adjuster then contacts the property owner within a reasonable period of time after notification of the loss, such as 48 hours 312. The insurance adjuster inspects the property soon after the initial contact 314, such as 48 hours after the initial contact. If a construction and/or an emergency vendor is needed, the insurance adjuster may be required to assign the vendor through the service provider 102. In this way, the vendor may be an insurer-approved vendor who can then perform the work on an emergency or non-emergency basis 316. In either case, the insurance adjuster performs an inspection and determines the initial scope of the work to be performed and uploads the documentation such as digital photographs to the web site 124 within a predetermined period of time such as 7 days as indicated in step 318.

Dialogue 320 then occurs with the documentation (such as estimates, diagrams, additional photos, reports, notes, and the like) uploaded for circulation and inspection to the web site 124 within a predetermined period of time, such as 15 days at step 330. Upon posting the documentation to the web site 124, the insurer reviews the documentation and approves the estimate and provides feedback to the insurance adjuster as indicated in step 332. Upon completion of the dialogue between the insurance adjuster and the insurer 320, inquiry is made of the insured as to whether or not he or she would like the vendor to perform the work.

If the insured does not want the vendor to perform the work 340, the adjuster is notified and the file is closed 342. The file is closed 344, and the appropriate terminal reports are generated 346 and, in some cases, posted to the web site 124. If the insured does want the vendor to perform the work 360, the work is performed by the vendor and associated documentation submitted to the web site 124 in order to update the status of the claim 362. The work is then completed by the vendor at some future point 364, and a certificate of completion is then posted on the web site 366. The property owner may then be directed to a page at the web site in order to submit responses to survey questions 368. Such feedback may be in the form of an invitation by email with an appropriate Internet web page link or the like. Once the property owner has made the survey report via the web site 368, the adjuster is notified and issues payment 370. The file is then closed 344 with the appropriate reports 346 generated and, as appropriate, posted to the web site 124.

In the present invention claims are initially assigned to the service provider 102 via the web site 124 or otherwise, in order to initiate the process. If the claim is one that must be handled immediately, it is generally considered to be a “emergency” claim, and in order to diminish the injury to, persons or property, immediate action is taken with respect to the claim. If the claim is not an emergency claim, then more time can be taken before addressing the claim.

In all, if not most, cases all of the claim data, documentation, and appropriate correspondence and the like are made available through the web site at a conveniently-named domain/URL such as www.911claim.com.

If emergency services are needed in response to a claim, the service provider then contacts, as by paging, the next vendor in a rotation schedule. The vendor is one that has been pre-approved by the insurer. The vendor is then given a reasonable period of time in which to respond, such as 15 minutes. If the first initial time period passes without response to the first page, the vendor is then paged again. A second period of time that is reasonable under the circumstances is allowed to pass before another vendor is selected. Such a second period of time may be on the order of 10 minutes. The loss or claim is then assigned to the vendor who has been previously approved by the pertinent insurance company of the insured.

Where no emergency services are needed, the service provider 102 may assign the claim electronically to an insurance company-approved vendor or independent adjuster. The vendor or independent adjuster may then have a longer period of time in which to respond and can conveniently self-arrange for an appropriate time in which to respond to the claim assignment.

The vendor or independent adjuster that handles the claim with the adjuster making the appropriate approval of any compensation or action taken by a vendor. Once the work has been completed, a certificate of completion can be posted on the web site 124 in order to formally establish the completion of the work. Email notification or otherwise (including wireless notification) can be given to the interested parties in order to notify them that such a certificate of completion has been posted and established.

Making contact with the insured may take place according to the emergency nature of the claim. If the claim is an emergency claim, the insurance company approved vendor preferably contacts the insured immediately, such as within 5 minutes from receiving the assignment from the service provider 102. For non-emergency claims, the approved vendor may be given a longer period of time in which to contact the insured, such as 24 hours. Additionally, the independent adjuster may also be given a similar or more extended period of time in which to contact the insured, such as 48 hours.

With respect to inspection of the loss or claim, emergency claims are handled in an expeditious manner. Emergency claims by needs are handled more quickly than non-emergency claims. For emergency claims, the approved vendor is preferably at the loss site as soon as possible, preferably within 2 hours or less, to perform the emergency services. Such emergency services may include plumbing for damaged pipes or electrician services for power losses, or the like. For non-emergency claims, the vendor may take additional time in order to be at the loss site, and this allows the approved vendor to employ his own schedule with regards to repairing the loss at the loss site. A reasonable amount of time is generally considered to be approximately 48 hours or less from the time the assignment is made to the approved vendor. For the independent adjuster, a similar amount of time, such as 48 hours, may be appropriate for the independent adjuster to visit and inspect the loss site. Such 48 hours calculated from the time the contact is made by the independent adjuster with the insured.

In order to ensure that the insured's claim has been properly handled, the service provider 102 may inquire or query of the insured to ensure that the work has been performed appropriately and timely. For emergency claims, the approved vendor may call the service provider immediately after the initial emergency services have been performed. This notifies the service provider that the vendor has performed the work, or at least is representing to the service provider that such work has been completed or performed. The service provider's Customer Care Representatives (CCRs) may then follow up with the insured to make sure that he or she is satisfied with the work that the approved vendor has performed and that the property is secured and safe. For emergency claims, a “Vendor's First Report” is completed and posted on the web site 124 for review generally within 12 hours from the assignment of the loss, but other time periods may also be usefully implemented in order to rapidly address the loss.

By providing a web-based repository for all reports and documentation, the insurance company enlisting the services of the service provider 102 can receive detailed reports on a daily, monthly, and annual basis for all new claims handled via the web site 124. These reports can also be divided, regional, state-based or office-based breakdowns for analysis. The insurance company and the approved vendor and/or approved independent adjuster can all exchange claim information via a web site and in a secure manner. The approved vendor can inform the insurance company and service provider 102 via the web site 124 that the work is completed by posting the certificate of completion as indicated in step 256. By posting the documentation on a conveniently accessible and available web site 124, the insurance company can then approve all of the work before initiation and issue payments once document representations are made of work completion.

According to the present inventive method, certain resources and facilities must be readily available. The approved vendors and approved independent adjusters must generally be able to respond and perform emergency services 24 hours a day, 7 days a week. This may require some rotational basis for the vendors and adjusters, so that no one person is overly burdened. Correspondingly, the insurance company and/or service provider 102 must have the ability to contact approved vendors and approved independent adjusters via after hours service including emergency pagers, cell phones, or the like. Wireless email or the like may also provide a readily-available means by which contact can be established and messages passed. Greater convenience is provided by the present inventive method, as the service provider 102 is available 24 hours a day 7 days a week. Especially for emergency losses, this provides means by which insureds can have their losses and claims readily addressed and remedied by approved vendors. As mentioned above for plumbing leaks and power losses, such vendors can readily repair any property damage and minimize further repair from water loss or power outage.

An adjuster for the insurance company may be on call and available to the service provider 102, approved vendor, and/or approved independent adjuster for special issues.

In order to confirm a claim or loss, the service provider 102 may contact the policy holder immediately after receiving an emergency claim. The policy holder may be the person who initially called the service provider 102 or, as for an apartment manager, may be the property owner or other insured. In order to provide better assessment and allocation of risk, the approved vendor and independent adjuster may be required to have at least $1 million in general liability insurance. Correspondingly, both the vendor and adjuster preferably have full workers compensation insurance for their employees and should generally require all their subcontractors to do the same.

The vendor and adjuster must preferably have all applicable federal state and city licenses required for their trades, and in order to validate the vendor's role in addressing the loss or claim, the vendor preferably is required to provide the property owner with an introduction letter from the insurance company.

By providing emergency service for claims and losses, insureds are available to lodge claims 24 hours a day 7 days a week. Generally, response times are on the order of 15 minutes or less once the page to the vendor has been transmitted. The vendor then contacts the policyholder generally within five minutes from receiving the assignment, and the vendor is at the loss site within 2 hours or less.

The vendor then contacts the service provider 102 as soon as the work is completed and completes a “Vendor's First Report” within 12 hours from receiving the assignment. Additionally, all photos and diagrams may be uploaded by the vendor to the web site 124 within 24 hours of receiving the assignment, and the vendor may upload an emergency estimate within 48 hours from receiving the assignment. Generally, the vendor closes the file within 24 hours from the time the emergency work is completed. As a general rule, if emergency loss is anticipated to exceed $5,000 in expenses and/or costs, the vendor must note it on the Vendor's First Report immediately. This function is preferably performed within 12 hours from the time the emergency services are provided.

With respect to non-emergency claims, the approved vendors should contact the property owner within 24 hours of the assignment and inspect the property within 24 hours after contacting the property owner. The vendor may then upload all estimates, diagrams, photos, work authorizations, documentation, and other materials to the web site 124 within 48 hours of the time of the inspection.

For the independent adjuster, he or she should acknowledge receipt of the claim assignment within 12 hours and contact the policyholder within 48 hours from receiving the assignment and within 24 hours where the losses are large. Large losses may be determined by a certain arbitrary threshold on the order of anywhere from $100,000 to $1 million. Under other circumstances, $5,000 or $10,000 may be considered large, and the present inventive method may be adapted to almost any such threshold losses. The independent adjuster should inspect the loss site within 48 hours from contacting the policyholder and upload the initial scope and photos of the loss site within 7 days from the inspection. The independent adjuster should upload any additional photos, diagrams, notes, reports, estimates, and/or any other documents to the web site within 15 days of the assignment, as well as following all other existing procedures with respect to making adjustment for the loss or claim.

With respect to deductibles, the vendor attempts to collect the deductible prior to starting any work. In the event that the insured is unable or unwilling to pay the deductible at the time the services are rendered, the vendor may collect at a later time. However, under some circumstances, the deductible may be required before starting any work. If the vendor does collect the deductible, the vendor preferably makes note of it on the estimate and on the web site 124 with the Vendor's First Report to inform the adjuster and other parties. In the event the insured does not want to pay the deductible, the vendor may contact the insurance company immediately in order to obtain instructions as to how to proceed. If the vendor is unable to collect the deductible and the vendor has attempted to collect the deductible, the insurance company may pay the vendor in lieu of payment by the insured.

Preferably, the vendor follows all federal, state and local OSHA maximum safety procedures and requirements to prevent additional losses from occurring during the repair of the original loss.

With respect to the establishment of standards used for estimating the loss, the vendors may use their own existing estimating system, and such estimates may then be uploaded to the web site 124. A hard copy of the estimate may be sent to the insurance company if needed or requested. The vendor should diagram the damaged areas with appropriate measurements and copies of the diagram in hard form may be sent to the insurance companies as an accompanying document with the estimate.

In establishing and documenting the loss, digital photographs are preferred as these are most easily uploaded to the web site 124. Hard copies of the photos may be mailed with the estimate if needed or required, and at least one photo of the damaged area, one photo of the cause of loss, and one photo of the risk (or the front of the property) are preferably obtained. If more photos are needed, the vendor may generally take as many more additional photos as desired or considered necessary.

Generally, the vendor must take prior authorization before performing any work, and the vendor must scan and upload a copy of the work authorization with the estimate to the web site 124. The work authorization generally must have a “Direction to pay” clause, and the hard copy of the work authorization may be mailed to the insurance company if required.

The vendor preferably obtains a certificate of completion after completion of the work, and the certificate of completion is then posted on the web site within 48 hours from such completion work.

Payment for claims are generally issued directly to the vendor is the claim is under a certain predetermined amount, such as $7,500. Generally, the work authorization is uploaded prior to the start of any work except for any emergency losses. Emergency losses have the work authorization uploaded to the web site 124 within 24 hours of the initial claim. A signed certificate of completion is generally uploaded to the web site 124 after completion of the work. Payments for any claim are generally issued jointly to the vendor and the insured for all losses over a predetermined threshold amount, such as $7,500, if the work authorization is uploaded to the web site 124. All estimates generally include the appropriate tax information necessary for processing and accounting, including tax ID numbers.

If the insured requests a vendor to perform any type of repair work, certain procedures may be advantageously implemented. If the claim is over a certain threshold amount, such as $25,000, then the insured may request a contractor, and the independent adjuster may call the service provider 102 for a referral. The service provider may make the assignment to an insurance company approved contractor, prior to the performance of any work. If the claim is over a certain threshold amount, such as $25,000, then the independent adjuster preferably is required to contact the service provider 102 for a vendor referral. The service provider 102 preferably then makes the assignment with respect to the vendor.

If at any time there are issues regarding insurance coverage or other coverage questions, the vendor preferably does not answer such questions, but preferably contacts the service provider 102 and/or insurance company immediately. If the contact must be made after normal business hours, the service provider 102 may be the party contacted by the inventor. Generally, the vendors do not interpret policy or coverages at any time, as they are not property qualified to do so, nor does the vendor preferably discuss policy or coverage issues at any time. The types of losses that generally require the insurance company to be contacted immediately include: sewage loss, large fires (generally those involving more than 2 rooms), explosions, arson, personal injury, cases where the insured needs to move to another location, surface water, liabilities issues, long-term damage, maintenance issues, mold and/or mildew, or any other reason the inventor finds important to contact the insurance company.

If at any time the vendor sees a potential for subrogation, the vendor preferably asks the insured to save the item in question. If the vendor takes a clear picture of the item, this should be noted on the Vendor's First Report immediately in rendering emergency services by the vendor. Certain special issues may be addressed in consultation with the service provider 102 and/or insurance company including ITEL (third party carpet evaluation firm), asbestos, mold and mildew, other testing and abatement, lead testing and abatement, leak detection, and/or plumbing

Generally, the requirements for implementing the present invention include any machine that can access web pages distributed over the Internet. These include personal computers, palm or other hand-held devices, wireless communications devices, cell phones, and the like. Generally, for personal computers, a Windows® operating system such as Windows® 95 or higher, as well as a scanner and digital camera, provide the basic hardware infrastructure preferred in accessing the web site 124. The software infrastructure should include a sufficiently advanced Internet browsing system such as Netscape and/or Internet Explorer, email programs, digital photo software and a document generating and/or capturing program such as Adobe Acrobat 4.0 or higher. Generally, such a document program should be both a reader and a writer of information to a file. The insurance company, independent adjusters, and approved vendors preferably all have Internet access through modems and other communications devices at access speeds of 14,400 baud or better with an understanding that the faster the speed the less time it will take to upload photos, estimates, and diagrams.

While the present invention has been described with regards to particular embodiments, it is recognized that additional variations of the present invention may be devised without departing from the inventive concept.

What is claimed is:

1. A method for handling insurance claims via a computer network, the steps comprising:
providing a claim-handling service provider to receive and administer claims made by insureds, said claim-handling service provider including secure data storage space accessible via a large scale computer network;
said claim-handling service provider determining if a new claim is an emergency claim or if said new claim is not an emergency claim;
said claim-handling service provider contacting a vendor to perform emergency services by effecting repair or taking preventative action if said new claim is an emergency claim;
said vendor performing said emergency services;
said vendor transmitting data regarding performance of said emergency services to said claim-handling service provider including transmitting data to said secure data storage space via said large scale computer network; and
said claim-handling service provider making said performance data available to appropriate parties via said large-scale computer network; whereby
an emergency claim may be determined and handled by said claim-handling service provider in a timely manner that repairs and/or mitigates damage arising from a source of said emergency claim.

2. A method for handling insurance claims via a computer network as set forth in claim 1, further comprising:
determining if an insurance adjuster is required to handle said new claim; and
contacting an insurance adjuster, said contacting performed by said claim-handling service provider; whereby
an insurance adjuster may be contacted and engaged prior to contacting said vendor.

3. A method for handling insurance claims a computer network as set forth in claim 1, wherein said step of said vendor transmitting data further comprises:
said vendor contacting said claim-handling service provider;
said vendor informing said claim-handling service provider of said vendor's performance; and
said vendor transmitting a first report to said claim-handling service provider via said large-scale computer network for storage, retrieval, and archiving.

4. A method for handling insurance claims computer network as set forth in claim 3, further comprising:
said claim-handling service provider contacting an owner of property subject to said new claim;
said claim-handling service provider inquiring of said owner as to said owner's satisfaction with said vendor's performance; and
recording said owner's response for future reference.

5. A method for handling insurance claims network as set forth in claim 4, further comprising:
storing reports and documents on said secure data-storage space; whereby
to the extent possible, a paperless claims-handling process is achieved.

6. A method for handling insurance claims as set forth in claim 1, further comprising:
said claim-handling service provider using said secure data-storage space for documents and reports for shared online handling of said new claim if said new claim is not an emergency claim; whereby
interested parties, including an insurer, may lodge, review, and reference said documents and reports for said new claim to thereby expedite said non-emergency claim and make processing of said non-emergency claim more efficient and less expensive.

7. A method for handling insurance claims set forth in claim 2, further comprising:
proceeding to contact said vendor if said new claim is an emergency claim; or
using said secure data-storage space for documents and reports for shared online handling of said new claim if said new claim is not an emergency claim; whereby
said insurance adjuster may use said vendor if needed for an emergency claim and use said secure data-storage space for a non-emergency claim.

8. A method for handling insurance claims forth in claim 1, further comprising:
providing a survey to an owner of property subject to said new claim, said survey made available to said owner via said large-scale computer network.

9. A method for handling insurance claims via a computer network, the steps comprising:
providing a claim-handling service provider to receive and administer claims made by insureds, said claim-handling service provider providing secure data storage space accessible via a large scale computer network;
said claim-handling service provider determining if a new claim is an emergency claim or if said new claim is not an emergency claim;
said claim-handling service provider contacting a vendor to immediately perform emergency services by effecting repair or taking preventative action if said new claim is an emergency claim;
said claim-handling service provider determining if an insurance adjuster is required or needed to handle said new claim and contacting an insurance adjuster if said claim-handling service provider determines that an insurance adjuster is required or needed;
said vendor performing services to repair or mitigate damages from a source of said new claim;
said vendor transmitting data regarding performance of said services to said claim-handling service provider including transmitting data to said secure data storage space via said large scale computer network, including said vendor contacting said claim-handling service provider and said vendor informing said claim-handling service provider of said vendor's performance;
said vendor transmitting a first report to said claim-handling service provider via said large-scale computer network for storage, retrieval, and archiving;
said claim-handling service provider storing reports and documents on said secure data-storage space so that to the extent possible, a paperless claims-handling process is achieved;
said claim-handling service provider making said performance data available to appropriate parties via said large-scale computer network; and
said claim-handling service provider using said secure data-storage space for documents and reports for shared online handling of said new claim if said new claim is not an emergency claim so that interested parties, including an insurer, may lodge, review, and reference said documents and reports for said new claim to thereby expedite said non-emergency claim and make processing of said non-emergency claim more efficient and less expensive; whereby
both emergency and non-emergency claims may be determined and handled by said claim-handling service provider in a timely manner so that for an emergency claim, repairs and/or mitigation of damage arising from a source of said emergency claim may be timely effected, and for a non-emergency claim, an efficient and less expensive procedure may be achieved for handling said new claim

10. A method for handling insurance claims via a computer network as set forth in claim 9, the steps further comprising:
said claim-handling service provider contacting an owner of property subject to said new claim;
said claim-handling service provider inquiring of said owner as to said owner's satisfaction with said vendor's performance; and
said claim-handling service provider recording said owner's response for future reference.

11. A method for handling insurance claims via a computer network as set forth in claim 9, the steps further comprising:
providing a survey to an owner of property subject to said new claim, said survey made available to said owner via said large-scale computer network.

12. A method for handling insurance claims via a computer network, the steps comprising:
determining if a claim by an insured qualifies for handling by a claim-handling service provider and using an existing claims-handling policy that does not include said claim-handling service provider if said new claim does not qualify for handling;
said claim-handling service provider having a web site to which documents may be uploaded and from which documents may be downloaded;
assigning said claim to said claim-handling service provider for handling by said claim-handling service provider;
providing a vendor, said vendor contacting an owner of property subject to said claim;
said vendor inspecting said property;
said vendor providing documentation including estimates, diagrams, photos, or notes;
said documentation uploaded to said web site by said vendor;
providing an adjuster, said adjuster reviewing said documentation by downloading said documentation from said web site;
determining if said insured wants said vendor to perform work on said property;
performing and completing said work upon said property;
posting a certificate of completion by upload to said web site;
contacting said owner to ensure owner is satisfied with said work; and
notifying said adjuster of owner's satisfaction so that said adjuster may make payment on said claim; whereby
said claim may be handled more efficiently and with less expense.

13. A method for handling insurance claims via a computer network, the steps comprising:
assigning a claim to a claim-handling service provider for handling by said claim-handling service provider;
said claim-handling service provider having a web site to which documents may be uploaded and from which documents may be downloaded;
notifying an insurance adjuster of said claim;
said insurance adjuster contacting a property owner;
said insurance adjuster inspecting property owned by said property owner and subject to said claim;
said insurance adjuster contacting said claim-handling service provider if construction and/or an emergency vendor is needed;
said insurance adjuster determining an initial scope of said claim and obtaining photographs of said claim;
said insurance adjuster documenting said claim and uploading initial documentation including said initial scope and said photographs to said web site;
said insurance adjuster uploading additional claim documentation to said web site including estimates, diagrams, additional photos, reports, and/or notes;
reviewing said initial and additional documentation, said reviewing performed by an insurer;
determining if said insured wants work performed to remedy damage associated with said claim;
performing said work to remedy said damage;
documenting said performance of said work by uploading performance documentation to said web site;
uploading a certificate of completion to said web site upon completion of said work;
providing said property owner with a survey via said web site regarding said work performed; and
notifying adjuster of said completion of said work and issuing payment according to said completion; whereby
said claim may be processed in conjunction with said web site which facilitates document processing and distribution regarding said claim.
